(19) United States
(12) Patent Application Publication
(10) Pub. No.: US 2008/0017699 A1
(43) Pub. Date: Jan. 24, 2008

(54) AUTOMATIC SYSTEM OF LAUNDRY

(76) Inventor: Moon-Suk Jang, Whipplay, NJ (US)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/532,481

(22) Filed: Sep. 15, 2006

(30) Foreign Application Priority Data
Jul. 19, 2006 (KR) 10-2006-0067374

(51) Int. Cl. G06F 17/00; G06K 7/10

(52) U.S. Cl. 235/375; 235/462.13

(57) ABSTRACT

This invention relates to the automatic laundry system that prevents the error of sorting the laundry incorrectly and thus, reduces the economic loss caused by the mistake and improves the efficiency of the service. This system is comprised of the User's Terminal that sends/receives the stored information to/from the outside; the Wireless Modem that enables the communication between the User's Terminal and the Wireless Scanner; the Bar Code Modem to print the bar code form detailing the customer and laundry information that are recorded in the Bar Code; the Wireless Scanner that reads the bar code and sends the information to the User's Terminal after finishing the process of laundry work and the Assortive Indicator that stores the information of laundry that is put on the Assembly Hook from the said User's Terminal and displays the Customer Identification Number and Unsorted Quantity to the user and sends the stored laundry information to the said User's Terminal and at the same time, displays the location of laundry on the Assembly Hooks to the user.

### CROSS-REFERENCE TO RELATED APPLICATIONS

This application is based on and claims priority to Korean Patent Application No. 10-2006-0067374 filed on Jul. 19, 2006 in the Korean Intellectual Property Office (KIPO), the entire contents of which are hereby incorporated by reference.

### BACKGROUND OF THE INVENTION

1. Field of the Invention

This invention relates to an automatic system of laundry, more specifically, it is an automatic system of laundry that prevents the error of sorting the laundry incorrectly when they are put into the service initially and thus, reduces the economic loss caused by the mistake and improves the efficiency of the service on the whole.

2. Background of the Related Art

Washing is to get rid of the dirt on textiles such as clothing, bedding table supplies furniture supplies, etc by giving a pressure chemically with a proper detergent and mechanically with a machine, and washing or boiling the dirty laundries in the water which is dissolved with a detergent and other supplementary shops, dry them, iron them after the starch, and dry clean them if necessary, all these are the work of washing.

The objective of washing is to recover the beauty and sanitation of clothing by getting rid of dirt and to release the weariness of textile and to improve the durability. In order to achieve these, many uses the professional laundry service.

And, at the laundry shop (small, medium and large sized), they perform the work of sorting and wrapping the laundry, attaching the name of the customer or customer tag on each laundry when they come in, and after finishing the progress of work (wash, mend and iron, etc), hang them on the assembly hooks together with the invoice detailing the name of the customer or customer tag and the quantity of laundry and sort/wrap them by the customer, and send them to the customer.

However, in the case of sorting the laundry of more than thirty simultaneously the process of confirming the name of customer or customer tag after finishing the laundry and hang them on the assembly hooks with the invoices detailing the name or the tag no and the quantity of them one by one can be a very tedious work and costs a lot of time, not to mention the high probability of making mistakes.

Because of this, if incorrectly sorted laundry is sent, the customers will demand the compensation and the laundry service will lose the confidence of their customers and the worst of all, they may lose the businesses from these customers as a consequence.

### SUMMARY OF THE INVENTION

The present invention aims at solving the abovementioned problem, the objective of this invention is to provide the automatic system of laundry that prevents the economic loss caused by sorting the laundry incorrectly by customer and also by reducing the required time to sort the laundry by each customer considerably, it improves the confidence and efficiency of the service.

### BRIEF DESCRIPTION OF THE DRAWINGS

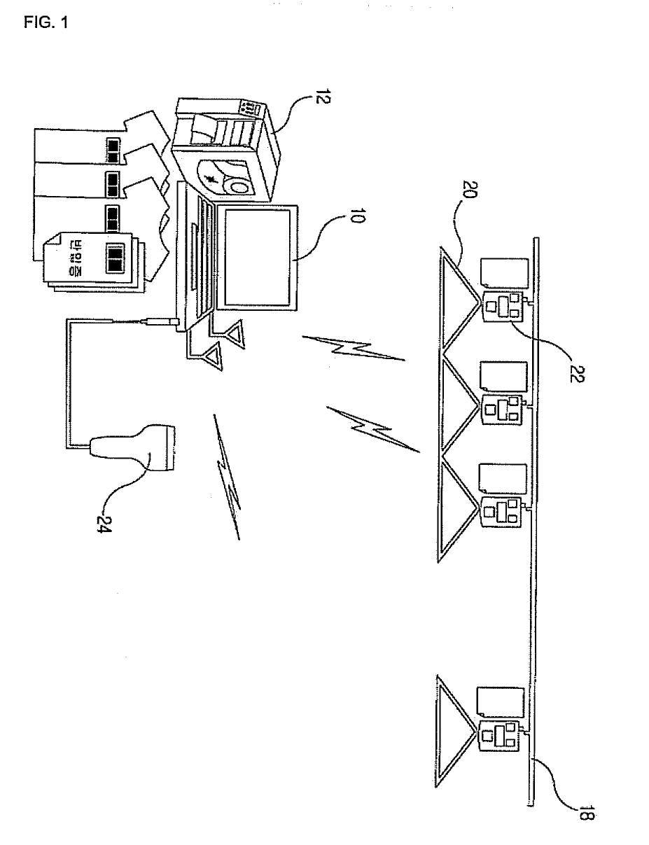

The FIG. 1 is a compositional drawing showing the automatic system of laundry in accordance with this invention;

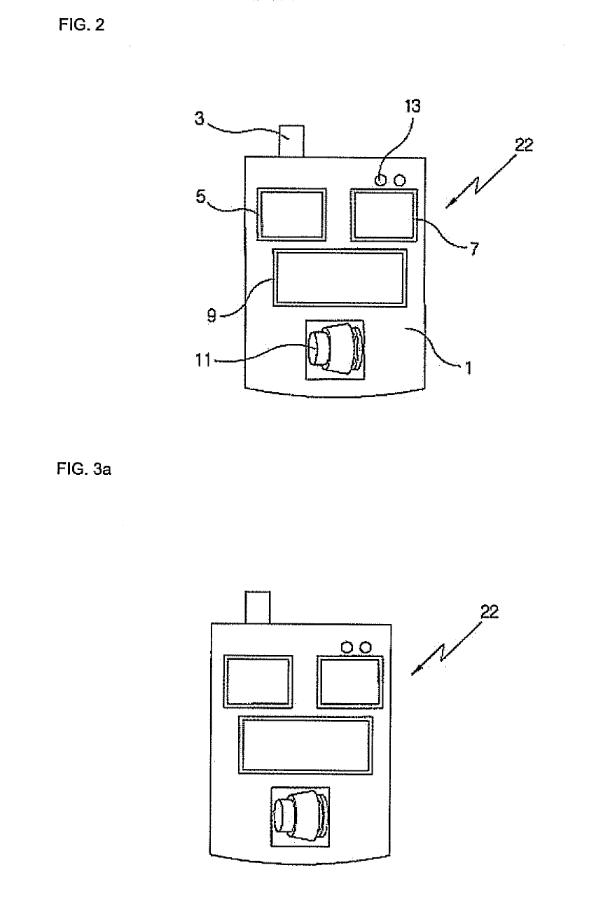

The FIG. 2 is a magnified diagram of the Assortive Indicator shown in the FIG. 1;

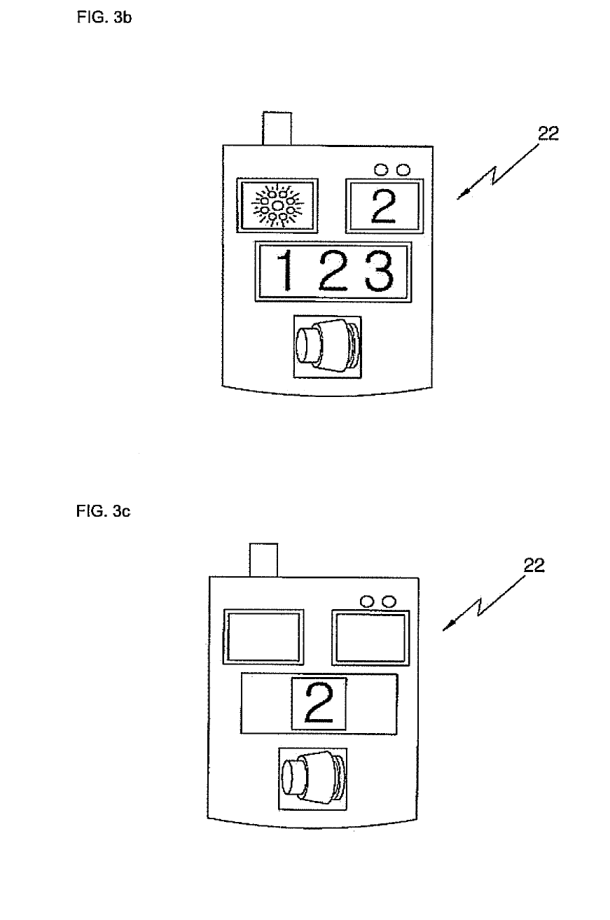

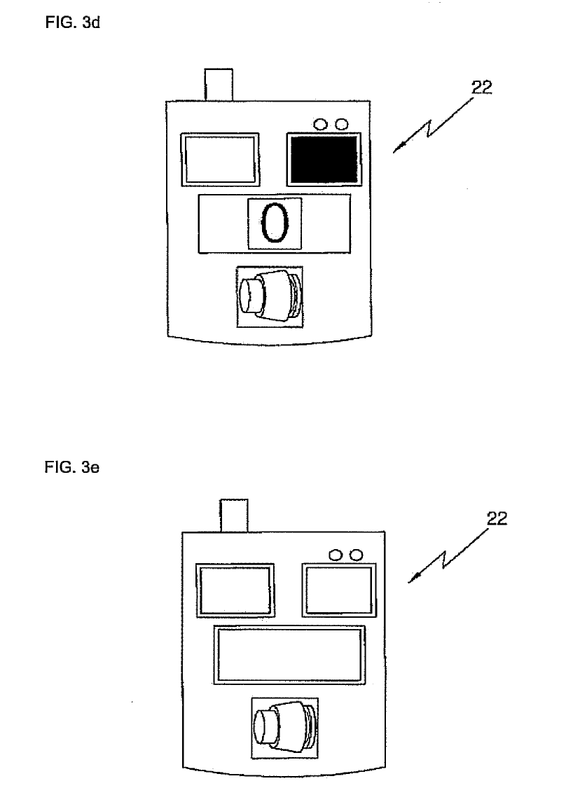

The FIG. 3a and FIG. 3e are the functional diagrams of the Assortive Indicator shown in the FIG. 1.

### TECHNICAL OBJECT & EFFECT OF THE PRESENT INVENTION AND DETAILED DESCRIPTION OF THE CONSTITUTION AND FUNCTION OF INVENTION

### TECHNICAL OBJECT OF THE PRESENT INVENTION

In order to achieve the abovementioned objective, the present invention is composed of the followings;

According to the input of user's key, it stores the laundry information (customer identification no., quantity, in/out time of laundry and type of laundry, color code, etc) and the customer information (name of customer, telephone no, address, etc) to the User's Terminal (10) and sends/receives the stored information to/from the outside using this; and

The said User's Terminal (10) connects at one side, but a Wireless Modem that enables the communication between the User's Terminal and the Wireless Scanner;

The said User's Terminal (10) connects at one side, but according to the control of the said User's Terminal (10), the laundry is programmed in accordance to the customer identification no, quantity and the time of taking the laundry recorded in the Bar Code when they are put in, and a Bar Code Modem (12) is to print the bar code form that is attached to the laundry;

Installed in one side of the Storage (14) that helps keeping and moving the laundry after the process of laundry work (washing, mending and ironing, etc.) which is possible to be put/taken out and read the bar code that is attached to the laundry and sends the information to the User's Terminal (10) by a Wireless Scanner (16) through a Wireless Terminal (10-1); and

When putting the finished laundry in the storage to the Assembly Hooks (20) from the said User's Terminal (10), the Assortive Indicator (22) installed on the upper body of the Assembly Hook that is hung on the Ceiling Bar (18) storing the laundry after receiving the information of laundry that is put on the said Assembly Hooks (20) displays the customer identification no and the quantity of unsorted laundry to the customer and sends the information of stored laundry to the said User's Terminal (10) and at the same time, displays the location of laundry that is put on the Assembly Hooks (20) to the customer.

### DETAILED DESCRIPTION OF THE CONSTITUTION OF FUNCTION OF INVENTION

A constitution and function of the present invention will now be explained with reference to the accompanying drawings.

As illustrated in the FIG. 1, the automatic system of laundry, according to the input of user's key, is to store the laundry information (customer identification no., quantity, in/out time of laundry and type of laundry, color code, etc) and the customer information (name of customer, telephone no, address, etc) to the User's Terminal (10) and to send/receive the stored information to/from the outside using this and the above User's Terminal (10) that is connected at one side, but a Wireless Modem that enables the communication between the User's Terminal and the Wireless Scanner;

The said User's Terminal (10) connects at one side, but according to the control of the said User's Terminal (10), the laundry is programmed in accordance to the customer identification no, quantity and the time of taking the laundry recorded in the Bar Code when they are put in, a Bar Code Modem (12) is to print the bar code form that is attached to the laundry;

Installed in one side of the Storage (14) that helps keeping and moving the laundry after the process of laundry work (washing, mending and ironing, etc.) which is possible to be put/taken out and read the Bar Code that is attached to the laundry and send the information to the User's Terminal (10) by a Wireless Scanner (16) through a Wireless Terminal (10-1); and

When putting the finished laundry in the Storage to the Assembly Hooks (20) from the said User's Terminal (10), the Assortive Indicator (22) installed on the upper body of the assembly hooks that is hung on the Ceiling Bar (18) storing the laundry after receiving the information of laundry that is put on the said Assembly Hooks (20) displays the customer identification no and the quantity of unsorted laundry to the customer and send the information of stored laundry to the said User's Terminal (10) and at the same time, displays the location of laundry that is put on the Assembly Hooks (20) to the customer.

At the other side of User's Terminal, a Bar Cord Reader (24) which reads the Bar Code can be installed additionally.

A Tag Printer can create the Arabian number on the left as shown in the picture below and a Bar Code on the right when print the laundry information on the tag thus, during the process of laundry, if the Bar Code Scanner fails to acknowledge the Bar Code due to the damage of a tag, the right customer can be found by the use of Arabian number on the left.

On the other hand, it is ideal to place an invoice at one side of the Assortive Indicator (22) detailing the laundry information (customer identification no., quantity, in/out time of laundry and type of laundry, color code, etc).

The said Assortive Indicator (22), as shown in the drawing two, has a square shaped body (22-1) having a variety of components including a control part (omit the illustration) that controls the Assortive Indicator and a storage part (omit the illustration) that stores the information;

An Antenna (22-3) that is installed on the upper part of the said body (22-1) receives the laundry information (customer identification no., quantity, in/out time of laundry and type of laundry, color code, etc) and the customer information (name of customer, telephone no, address, etc) from the User's Terminal (10) and at the same time, sends the stored information to the said User's Terminal (10) by being controlled from the control part;

A Location Notice Indicator (22-5) which is installed on the upper front part of the body, when puffing the laundry on the Assembly Hook (20) after receiving the information from the said User's Terminal (10), displays the location of laundry by being controlled from the control part to the user;

A Laundry Sorting Finish Indicator (22-7) that is installed on the other side of upper front part of the body displays the indication of the laundry being finished the sorting to the user by being controlled by the control part when putting the laundry on the Assembly Hook (20) after receiving the information from the said User's Terminal (10);

A Customer Identification Number and Unsorted Quantity Indicator (22-9) that is installed on the middle part of the main body, after receiving the information from the said User's Terminal (10) displays the customer identification no and the quantity that is not sorted;

A Reset Button (22-11) which is installed on the lower front part of the main body, according to the input of button by the user, the indicative motion of the said customer identification number and unsorted quantity indicator shows the quantity that is hung and the total quantity in turn and at the same time, initialize the Assortive Indicator (22).

A Regular Motion Indicator (22-13) installed on the front part of the main body displays the normal motion of the Assortive Indicator (22) by the control of control part;

An Irregular Motion Indicator (22-15) installed on the other side of front part of the main body displays the abnormal motion of the Assortive Indicator (22) to the user by the control of control part.

And, the said Assortive Indicator (22) is installed on each Assembly Hook (20) that is hung with several items on the Ceiling Bar (18).

After learning the composition of the automatic laundry system, the function of the said system will now be explained as follows;

First, when the laundry is put into the service, by using the key of the User's Terminal (10), the customer information (name of customer, telephone no, address, etc) and the laundry information (customer identification no., quantity, in/out time of laundry and type of laundry, color code, etc) are stored in the User's Terminal (10).

Then, according to the stored information, a Tag Printer (12) that is connected to the User's Terminal (10), after recording the customer identification no., quantity, in/out time of laundry to the Bar Code by the installed program, prints out the bar code tag together with an Arabian number.

After then, the user attaches the Bar Code Tag to the laundry; and,

When the Bar Code Tag is attached to the laundry, the laundry having the Bar Code Tag is put to the laundry equipment and performed the washing.

When the washing process (washing, mending and ironing etc) is finished, the finished laundry is put to the Storage (14) which can be moved around in order.

Here, in one side of the Storage (14), a Wireless Scanner (16) that is possible to be put on/taken out, is fixed, and the said Wireless Scanner (16) reads the Bar Code that is attached to the laundry and sends the information to the User's Terminal (10); and,

The user delivers the finished laundry from the said Storage (14) to the Assembly Hooks that are hung on the Ceiling Bar (18).

Here, the Assortive Indicator (22) is installed on the upper part of the assembly hooks (20), when the clothes are put on the said Assembly Hooks (20), the Assortive Indicator stores the information of laundry that is put on the Assembly Hooks (20) from the said User's Terminal (10), among the stored information, it displays the customer identification number and unsorted quantity to the user and sends the stored laundry information to the said User's Terminal (10) and at the same time, displays the location of laundry that is put on the said Assembly Hooks (20) to the user.

The detailed description on the motion of the said Assortive Indicator (22) is now explained as follows;

The said Assortive Indicator (22) is comprised of a Main Body (22-1) having a variety of components including a control part and a storage part, the Antenna (22-3), the Location Notice Indicator (22-5), the Laundry Sorting Finish Indicator (22-7), the Customer Identification Number and Unsorted Quantity Indicator (22-9), the Reset Button (22-11), the Regular Motion Indicator (22-13) and the Irregular Motion Indicator (22-15),

As shown in the drawing 3a, when the power is on, the Assortive Indicator (22) in the beginning is only functioned in the LED of the Regular Motion Indicator (22-13) while the said Regular Motion Indicator (22-13) always functions as long as the Assortive Indicator (22) is working regularly.

After then, the Antenna (22-3) receives the finished laundry information (customer identification no., quantity, in/out time of laundry and type of laundry, color code, etc) and the customer information (name of customer, telephone no, address, etc) from the User's Terminal (10). Also, the said Antenna (22-3) sends the stored information to the said User's Terminal (10) by being controlled from the control part.

And, as shown in the drawing 3b, the Location Notice Indicator (22-5) of the Assortive Indicator (22) that receives the finished laundry information and the customer information, when the laundry is put on the Assembly Hook (20), according to the information from the said User's Terminal (10), it displays the number of customer by the control of control part.

After putting the laundry to the Assembly Hook (20), as shown in the drawing 3c, when the user press the Reset Button (22-11), the Customer Identification Number and Unsorted Quantity Indicator (22-9) of the Assortive Indicator (22), among the laundry information received from the said User's Terminal (10), displays the quantity of unsorted laundry to the user by the control of control part.

And, when the sorting of laundry is completed, as shown in the drawing 3d, the Laundry Sorting Finish Indicator (22-7) of the Assortive Indicator (22) displays the indication of the laundry being finished the sorting to the user by being controlled by the control part. At this time, the Customer Identification Number and Unsorted Quantity Indicator (22-9) of the Assortive Indicator (22), among the laundry information received from the said User's Terminal (10), displays “0”, the number of LED that indicates the unsorted quantity of laundry.

On the other hand, the Irregular Motion Indicator (22-15) of the Assortive Indicator (22) displays the abnormal motion of the Assortive Indicator (22) to the user by the control of control part.

### EFFECT OF THE PRESENT INVENTION

As explained in the above, the present invention has an effect on preventing the error or loss of laundry in advance by removing the area of mistake when sorting the laundry out when they come in. Thus, it helps prevent the economical loss and the fall of confidence of laundry service and at the same time, by reducing the time to sort the laundry by each and every customer dramatically, it also help improve the effectiveness of its service.

What is claimed is:

1. An automatic laundry system that is comprised of the followings: the Users Terminal (10) to store the laundry information (customer identification no., quantity, in/out time of laundry and type of laundry, color code, etc) and the customer information (name of customer, telephone no, address, etc) according to the input of user's key and to send/receive the stored information to/from the outside using this; and,
A bar Code Modem (12) that is connected at one side of the said User's Terminal (10) but according to the control of the said User's Terminal (10), the laundry is programmed in accordance to the customer identification no, quantity and the time of taking the laundry recorded in the Bar Code when they are put in and prints the bar code form that is attached to the laundry; and,
A wireless Modem that is attached to the User's Terminal (10) which enables the communication between the Wireless Scanner (16) and the User's Terminal (10); and, A wireless Scanner (16) being installed in one side of the Storage (14) that helps storing and moving the laundry after the process of laundry work (washing, mending and ironing, etc.) which is possible to be put/taken out and reads the bar code that is attached to the laundry and sends the information to the User's Terminal (10); and,
An Assortive Indicator (22) installed on the upper body of the Assembly Hooks that is hung on the Ceiling Bar (18) storing the laundry after receiving the information of laundry that is put on the said Assembly Hooks (20), when putting the finished laundry in the storage to the Assembly Hooks (20) from the said User's Terminal (10), displays the customer identification no and the quantity of unsorted laundry to the customer and sends the information of stored laundry to the said User's Terminal (10) and at the same time, displays the location of laundry that is put on the Assembly Hooks (20) to the customer.

2. The said Assortive Indicator (22) in the above has the following components;
A square shaped Body (22-1) having a variety of components including the control part that controls the assertive indicator and the storage part that stores the information;
An Antenna (22-3) that is installed on the upper part of the said Body (22-1) receives the laundry information (customer identification no., quantity, in/out time of laundry and type of laundry, color code, etc) and the customer information (name of customer, telephone no, address, etc) from the User's Terminal (10) and at the same time, sends the stored information to the said User's Terminal (10) by being controlled from the control part;
A Location Notice Indicator (22-5) which is installed on the upper front part of the body, when putting the laundry on the Assembly Hook (20) after receiving the information from the said User's Terminal (10), displays the location of laundry by being controlled from the control part to the user;
A Laundry Sorting Finish Indicator (22-7) that is installed on the other side of upper-front part of the body displays the indication of the laundry being finished the sorting to the user by being controlled by the control part when putting the laundry on the Assembly Hook (20) after receiving the information from the said User's Terminal (10);
A Customer Identification Number and Unsorted Quantity Indicator (22-9) that is installed on the middle part of the main Body (22-1), after receiving the information from the said User's Terminal (10) displays the customer identification no and the quantity that are not sorted;
A Reset Button (22-11) which is installed on the lower front part of the main Body (22-1), according to the input of button by the user, the indicative motion of the said Customer Identification Number and Unsorted Quantity Indicator (22-9) shows the quantity that is hung and the total quantity in turn and at the same time, initialize the Assortive Indicator (22); and,
A Regular Motion Indicator (22-13) installed on the front part of the main Body (22-1) displaying the normal motion of the Assortive Indicator (22) by the control of control part; and,
An Irregular Motion Indicator (22-15) installed on the other side of front part of the main Body (22-1) displaying the abnormal motion of the Assortive Indicator (22) to the user by the control of control part.
A Wireless Modem that is attached to the User's Terminal (10) which enables the communication between the Wireless Scanner (16) and the User's Terminal (10).
